(19) United States
(12) Patent Application Publication
(10) Pub. No.: US 2016/0215142 A1
(43) Pub. Date: Jul. 28, 2016

(54) CURABLE ASPHALT COMPOSITION

(71) Applicant: Blue Cube IP LLC, Midland, MI (US)

(72) Inventors: Yi ZHANG, Shanghai (CN); Hanbang DONG, Shanghai (CN); Wei ZHOU, Shanghai (CN); Lei YAN, Shanghai (CN)

(73) Assignee: Blue Cube IP LLC, Midland, MI (US)

(21) Appl. No.: 14/914,485

(22) PCT Filed: Aug. 29, 2013
(86) PCT No.: PCT/CN13/82528

§ 371 Date: Feb. 25, 2016

(51) Int. Cl. C08L 95/00

(52) U.S. Cl. CPC C08L 95/005

(57) ABSTRACT

A curable asphalt composition comprising (i) an asphalt emulsion comprising: (a) asphalt; (b) a phenalkamine compound; (c) 0-5 wt % of an emulsifier, based on the total weight of the asphalt emulsion; (d) an acid; and (e) water; and (ii) a water borne epoxy resin; and the process of making the same.

### FIELD

The present invention relates to a curable asphalt composition and a method of preparing the same.

### INTRODUCTION

Asphalt emulsions are widely used in the road paving and maintenance application such as tack coats, fog seals, slurry seals and micro-surfacing. During application, aggregates and other additives (for example, fillers and dispersants) are usually added into the asphalt emulsion to obtain a pavement. However, the resultant pavement tends to deform or crack under repeated loadings.

To solve the above mentioned problems, conventional rubbers such as styrene-butadiene rubber (SBR) latex or styrene-butadiene-styrene (SBS) copolymers are commonly used to modify asphalt emulsions. Rubber-modified asphalt emulsions are usually supplied in one-component or two-component systems. Compared to unmodified asphalt emulsions, rubber-modified asphalt emulsions, upon drying, can provide better adhesion to a substrate and/or aggregates, which is critical attribute for improving the durability and maintenance life of paved road surfaces. However, rubber-modified asphalt emulsions still have deformation problems after repeated use, especially in the summer when the temperature of road surfaces in the summer sometimes reaches as high as 50 to 60° C. Moreover, rubber-modified asphalt-paved road surfaces usually suffer from aging problems.

Another common approach to modify asphalt emulsions is to mix asphalt emulsions with waterborne epoxy resins and conventional water-soluble amine hardeners. Epoxy resins upon curing have better aging resistance than conventional rubbers. Asphalt and epoxy resins are known to be incompatible, so the combination of asphalt and epoxy resin is usually not able to form an emulsion stable enough for storage and transportation to meet industrial requirements such as the JTG E20-2011 industry standard in China (hereinafter “the JTG E20-2011 standard”). Incumbent waterborne epoxy-modified asphalt compositions are usually supplied in a three-component system: an asphalt emulsion, a waterborne epoxy resin and a curing agent. These three components are usually stored separately in different tank cars or storage containers, and then mixed on-site at the time of application. Thus, these known epoxy-modified asphalt compositions are unable to be applied using existing conventional equipment and vehicles that are normally used for one-component or two-component rubber-modified asphalt emulsions described above. Hence, the use of epoxy-modified asphalt compositions with existing conventional equipment results in a significant increase in the amount of labor and equipment; and cost.

### SUMMARY

The present invention provides inter alia (1) a novel curable asphalt composition that can provide paved road surfaces with beneficial properties such as enhanced durability, maintenance life and thermal resistance relative to conventional rubber-modified asphalt emulsions; and (2) a novel curable asphalt composition that can be applied using conventional available equipment and vehicles commonly used for conventional rubber-modified asphalt emulsions.

The present invention is a novel curable asphalt composition comprising an asphalt emulsion containing a phenalkamine curing agent and a waterborne epoxy resin. Compared to conventional rubber-modified asphalt emulsions, the curable asphalt composition of the present invention, upon curing, surprisingly provides much higher pull-off adhesion strength from a concrete substrate at room temperature (20 to 25° C.), and in particular, at a temperature (for example, 50 to 60° C.) higher than room temperature. As one part of the curable asphalt composition, the phenalkamine containing asphalt emulsion has satisfactory storage stability. “Satisfactory storage stability” herein means that the solids content difference for the asphalt emulsion is less than 1% after one-day storage and less than 5% after 5-day storage at room temperature as measured by the T0655-1993 method described in the JTG E20-2011 standard. Thus, the curable asphalt composition of the present invention can be prepared and applied using conventional available equipment for a two-component system to combine the asphalt emulsion already containing phenalkamine with the waterborne epoxy upon application.

In a first aspect, the present invention provides a curable asphalt composition comprising:

(i) an asphalt emulsion comprising: (a) asphalt, (b) a phenalkamine compound, (c) 0-5 weight percent (wt %) of an emulsifier, based on the total weight of the asphalt emulsion; (d) an acid, and (e) water; and

(ii) a waterborne epoxy resin.

In a second aspect, the present invention also provides a process of preparing the curable asphalt composition of the first aspect; wherein the process comprises:

(I) mixing an emulsifier, a phenalkamine compound, an acid and water to form an emulsion;

(II) separately heating asphalt;

(III) mixing the separately heated asphalt and the emulsion obtained from step (I) to form an asphalt emulsion, wherein the asphalt emulsion contains 0-5 wt % of the emulsifier, based on the total weight of the asphalt emulsion;

(IV) mixing the asphalt emulsion and a waterborne epoxy resin to obtain the curable asphalt composition.

### DETAILED DESCRIPTION

The curable asphalt composition of the present invention comprises (i) an asphalt emulsion, and (ii) a waterborne epoxy resin. The asphalt emulsion useful in the present invention comprises (a) asphalt; (b) at least one phenalkamine compound; (c) 0-5 wt % of at least one emulsifier, based on the total weight of the asphalt emulsion; (d) at least one acid; and (e) water.

The asphalt useful in the present invention may be any asphalt known in the art, or mixtures of different types of asphalt. Examples of suitable asphalt include heavy traffic asphalt such as AH-70 or AH-90 asphalt, polymer-modified asphalt such as SBS- or SBR-modified asphalt, or mixtures thereof. Asphalt is usually a sticky, black and highly viscous liquid or semi-solid form of petroleum. The asphalt useful in the present invention may have a needle penetration at 25° C. of from 40 to 100 decimillimeters (dmm), from 50 to 90 dmm, or from 60 to 90 dmm according to the T0604-2011 method described in the JTG E20-2011 standard.

Suitable commercially available asphalt useful in the present invention may include, for example, Zhonghai 70^{#} asphalt, Zhonghai 90^{#} asphalt, Donghai 70^{#} asphalt, and Donghai 90^{#} asphalt all available from Sinopec; AH-70 asphalt and AH-90 asphalt both available from Shell; or mixtures thereof.

The concentration of the asphalt may be, based on the total weight of the asphalt emulsion, 10 wt % or higher, 45 wt % or higher, or even 50 wt % or higher, and at the same time, 70 wt % or lower, 65 wt % or lower, or even 60 wt % or lower.

The phenalkamine compound useful in the present invention, as component (b), may comprise any phenalkamine known in the art. The phenalkamine compound can act as a hardener for curing waterborne epoxy resins. The phenalkamine compound may be the result of the synthesis of a Mannich base curing agent, that is, a reaction product of cardanol or cashew nut shell liquid (CNSL), aldehyde, and a polyamine via the Mannich reaction (aminomethylation). CNSL mainly comprises cardanol and cardol.

The aldehyde for preparing the phenalkamine compound can be formalin solution, formaldehyde, paraformaldehyde, or any substituted aldehyde. In a preferred embodiment, paraformaldehyde is used in the present invention. The polyamine for preparing the phenalkamine compound can be aliphatic, cycloaliphatic, aromatic, polycyclic, polyamide, polyamidoamine, or mixtures thereof. Examples of suitable aliphatic polyamines include ethylenediamine (EDA), diethylenetriamine (DETA), triethylenetetramine (TETA), tetraethylenepentamine (TEPA), pentaethylenehexamine (PEHA), N-aminoethylpiperazine (N-AEP) and mixtures thereof. Examples of suitable cycloaliphatic polyamines include isophorone diamine (IPDA); 1,3-cyclohexanebis(methylamine) (1,3-BAC); 4,4′-methylenebis(cyclohexylamine) (PACM); and mixtures thereof. Examples of suitable polyoxyalkylene polyamines include JEFFAMINE™ D-230 and JEFFAMINE D-400 polyoxypropylenediamines available from Huntsman Corporation, and mixtures thereof. In some embodiments, the polyamines used in the present invention are DETA, polyoxypropylenediamine, polyoxyethylenediamine, or mixtures thereof. Examples of suitable aromatic polyamines include m-xylylenediamine (MXDA). The initial molar ratio of cardanol or CNSL:aldehyde:polyamine for the Mannich base hardener synthesis can vary in the range of 1.0:1.0-3.0:1.0-3.0, in the range of 1.0:2.0-2.4:2.0-2.2, or in the range of 1.0:1.4-2.4:1.4-2.2.

In a preferred embodiment, the phenalkamine compound useful in the present invention comprises a compound having Formula (I):

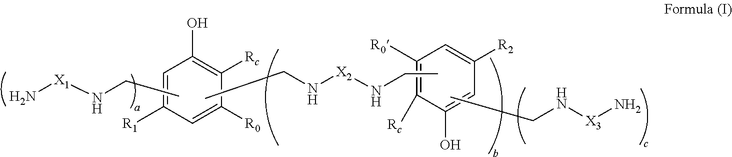

wherein R₀ or R₀′ is independently a straight-chain alkyl with 15 carbons containing 0 to 3 C═C bond(s), or a straight-chain alkyl with 17 carbons containing 1 to 3 C═C bond(s); R₁ or R₂ is independently hydrogen (—H) or hydroxyl (—OH); R_{c} can be hydrogen or carboxyl (—COOH); a is an integer from 0 to 2; b is an integer from 0 to 20; c is 0 or 1; wherein a+b+c≠0; X₁, X₂, or X₃ is independently a bivalent or multivalent group.

R₀ or R₀′ can be independently a straight-chain alkyl with 15 carbons containing 0 to 3 C═C bond(s) selected from the group consisting of —C₁₅H₃₁, —C₁₅H₂₉, —C₁₅H₂₇, and —C₁₅H₂₅; or a straight-chain alkyl with 17 carbons containing 1 to 3 C═C bond(s) selected from the group consisting of —C₁₇H₃₃, —C₁₇H₃₁, and —C₁₇H₂₉.

Also in Formula (I), a can be 1 or 2. b can be 10 or lower, 5 or lower, 3 or lower, 2 or lower, or even 1 or lower. Preferably, a is 1 or 2, b is 0, and c is 0.

X₁, X₂, or X₃ can be independently a bivalent or multivalent group selected from an aliphatic ethylene group having the structure of —(CH₂)ₘ—, wherein m is from 1 to 5, or from 1 to 3. X₁, X₂, or X₃ can also be independently an amino ethylene group having the structure of —(NH(CH₂)ₘ)₀—, wherein m is independently as previously defined, and n is from 1 to 20, from 1 to 15, or from 2 to 10.

X₁, X₂ or X₃ can be independently a bivalent or multivalent group selected from a polyoxyalkylene group comprising one or more ethylene oxide segments (—CH₂CH₂O—), propylene oxide segments (—CH(CH₃)CH₂O—), or combinations thereof.

X₁, X₂ or X₃ can also independently be a bivalent or multivalent group selected from a cycloaliphatic structure such as

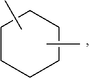

an aromatic structure such as

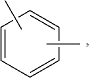

or a polycyclic structure such as

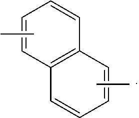

X₁, X₂ or X₃ can be independently a bivalent or multivalent group selected from an aliphatic carbonyl group having the structure of

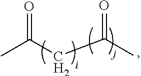

wherein j is from 0 to 1, and i is from 1 to 50, from 5 to 40, or from 10 to 35.

In some embodiments, X₁, X₂ or X₃ is independently a group having a hydrophilic-lipophilic balance (HLB) value of 4 or higher, 6 or higher, or even 8 or higher. HLB value herein is determined according to the Griffin Formula: HLB=20*Mh/M, wherein Mh is the molecular mass of the hydrophilic portion of a molecule and M is the molecular mass of the whole molecule (“Calculation of HLB Values of Non-Ionic Surfactants”, Journal of the Society of Cosmetic Chemists 5 (4): 249-56, 1954). Examples of suitable groups having such HLB value include the amino ethylene group described above, the polyoxyalkylene group described above, or mixtures thereof. In some embodiments, the phenalkamine compound containing such X₁, X₂ or X₃ group provides an asphalt emulsion with stability sufficient to meet the JTG E20-2011 standard even without the use of any conventional emulsifiers.

The phenalkamine compound useful in the present invention can be a reaction product of CNSL with formaldehyde and ethylenediamine, for example, D.E.H.™ 641 hardener available from The Dow Chemical Company (D.E.H. is a trademark of The Dow Chemical Company).

The concentration of the phenalkamine compound useful in the present invention, as component (b), may be, based on the total weight of the asphalt emulsion, 0.05 wt % or more, 0.1 wt % or more, or even 0.2 wt % or more, and at the same time, 15 wt % or less, 6 wt % or less, or even 2 wt % or less.

The phenalkamine compound may be in an amount sufficient to cure or partially cure the waterborne epoxy resin in the curable asphalt composition. The equivalent ratio of epoxy group in the waterborne epoxy resin to active hydrogen in the phenalkamine compound may be 1:0.5 or lower, 1:0.6 or lower, 1:0.7 or lower, or even 1:0.8 or lower, and at the same time, 1:2 or higher, 1:1.5 or higher, 1:1.2 or higher, 1:1.1 or higher, or even 1:1 or higher.

The asphalt emulsion useful in the present invention may be free of, or comprise one or more emulsifiers known in the art. The emulsifier can comprise a cationic emulsifier, a nonionic emulsifier, or a mixture of a cationic emulsifier and a nonionic emulsifier. In some embodiments, the emulsifier used in the present invention comprises one or more cationic emulsifiers. The cationic emulsifier may comprise an amine, and preferably a quaternary amine. Examples of suitable cationic emulsifiers include polyamines; imidazolines; alkyl betaines; alkylamido detaines; reaction products of polyamines with polycarboxylic acids, anhydrides or sulfonated fatty acids, their quaternization products; polyalkanol amines, their esterification products; mixtures of polyalkanol amines and carboxylic acids; quaternization products of polyalkanol amines, quaternization products of polyalkanol amines' esterification products; polyalklene amines, their reaction products with kraft lignin or maleinized lignin; or mixtures thereof. Examples of suitable nonionic emulsifiers include octylphenol ethoxylates, nonylphenol ethoxylates, dodecylphenol ethoxylates, or mixtures thereof.

Suitable commercially available emulsifiers useful in the present invention include for example INDULIN™ MQK-1M and INDULIN MQ3 emulsifiers available from MeadWestvaco Corporation, REDICOTE™ E4819 and REDICOTE EM44 emulsifiers available from Akzo Nobel, or mixtures thereof.

In some embodiments, the asphalt emulsion useful in the present invention is free of any conventional emulsifiers. In such embodiments, the phenalkamine compound acts as both a curing agent and an emulsifier.

When used, the emulsifier can be used in an amount known in the field. The concentration of the emulsifier may be, based on the total weight of the asphalt emulsion, 0 wt % or more, 0.01 wt % or more, 0.05 wt % or more, or even 0.1 wt % or more, and at the same time, 5 wt % or less, 3 wt % or less, 2 wt % or less, or even 1.6 wt % or less.

The asphalt emulsion useful in the present invention also comprises an acid such as inorganic acid, organic acid or mixtures thereof. In some embodiments, an inorganic acid is used. Examples of suitable inorganic acids include hydrochloric acid (HCl), phosphoric acid, nitric acid or mixtures thereof. The organic acid may be selected from formic acid, acetic acid, acrylic acid, succinic acid, malonic acid, oxalic acid, tartaric acid, citric acid or mixtures thereof. In a preferred embodiment, hydrochloric acid or oxalic acid is used in the present invention.

The acid useful in the present invention can be in an amount sufficient to achieve suitable pH value. The pH value of an emulsion comprising the phenalkamine compound described above, the acid, water and, if present, the emulsifier described above, is generally from 1.5 to 3, from 1.7 to 2.5, or from 1.8 to 2.2.

The asphalt emulsion useful in the present invention also comprises water.

In the asphalt emulsion useful in the present invention, the phenalkamine compound and asphalt described above are compatible with each other. Surprisingly, the asphalt emulsion has satisfactory stability for storage and transportation, and is able to meet the JTG E20-2011 standard.

In addition to the asphalt emulsion described above, the curable asphalt composition of the present invention further comprises (ii) a waterborne epoxy resin. The waterborne epoxy resin that is curable with the above phenalkamine compound can be selected from any conventional, water-dispersible epoxy compounds. The waterborne epoxy resin can be a dispersion of a liquid epoxy resin, a dispersion of a solid epoxy resin, or a dispersion of a mixture of a liquid epoxy resin and a solid epoxy resin. In some embodiments, the waterborne epoxy resin used in the present invention is a dispersion of a solid epoxy resin.

The waterborne epoxy resin useful in the present invention can be a self-emulsified epoxy resin. The self-emulsified epoxy resin may be in the form of an aqueous dispersion. The self-emulsified epoxy resin can be an adduct of an epoxy compound with a hydrophilic monomer or polymer containing at least one group selected from carboxyl, hydroxyl, sulfonate group, ethylene oxide group or amino group.

The waterborne epoxy resin useful in the present invention can be an emulsion or a dispersion of one or more epoxy compounds and a surfactant. The epoxy compounds can be solid epoxy resins or liquid epoxy resins. The epoxy compounds may include, for example, epoxy resins based on reaction products of polyfunctional alcohols, phenols, cycloaliphatic carboxylic acids, aromatic amines, or aminophenols with epichlorohydrin. Examples of suitable epoxy compounds in the waterborne epoxy resin include bisphenol A diglycidyl ether, bisphenol F diglycidyl ether, resorcinol diglycidyl ether, and triglycidyl ethers of para-aminophenols, reaction products of epichlorohydrin with o-cresol novolacs, hydrocarbon novolacs, phenol novolacs, or mixtures thereof. Suitable commercially available epoxy compounds in the waterborne epoxy resin may include, for example, D.E.R.™ 331, D.E.R. 332, D.E.R. 334, D.E.R. 337, D.E.N.™ 431, D.E.N. 438, D.E.R. 671 or D.E.R. 852 epoxy resins all available from The Dow Chemical Company (D.E.R. and D.E.N are trademarks of The Dow Chemical Company).

The surfactant useful herein can be a nonionic or ionic surfactant, which is used to emulsify the epoxy compounds described above in water. Preferably, the surfactant in the waterborne epoxy resin is a nonionic surfactant containing at least one epoxy group, which can react with reactive hydrogen in a hardener. In a preferred embodiment, the waterborne epoxy resin is a dispersion of a nonionic emulsified solid epoxy resin.

The waterborne epoxy resin useful in the present invention may have an epoxide equivalent weight (EEW) of 150 or higher, 200 or higher, 300 or higher, or even 350 or higher, and at the same time, 750 or lower, 600 or lower, 550 or lower, 500 or lower, or even 450 or lower. The waterborne epoxy resin may be in the form a dispersion or an emulsion having a solids content of 40 wt % or higher, 45 wt % or higher, or even 50 wt % or higher, and at the same time, 99 wt % or lower, 90 wt % or lower, 80 wt % or lower, 70 wt % or lower, or even 65 wt % or lower, based on the total weight of the waterborne epoxy resin.

The amount of the waterborne epoxy resin in the curable asphalt composition may be dependent on the concentration of the asphalt. For example, the weight ratio of solids of the waterborne epoxy resin to the asphalt may be 0.01:1 or higher, 0.02:1 or higher, 0.04:1 or higher, or even 0.05:1 or higher, and at the same time, 10:1 or lower, 5:1 or lower, 1:1 or lower, or even 0.5:1 or lower.

The curable asphalt composition of the present invention may optionally comprise aggregates. Aggregates are usually used for many applications such as micro-surfacing or slurry seal. “Aggregates” herein refers to a broad category of coarse particulate material used in construction, including for example sand, gravel, crushed stone, slag, recycled concrete, geosynthetic aggregates or mixtures thereof. Aggregates may be selected from dense-graded aggregates, gap-graded aggregates, open-graded aggregates, reclaimed asphalt pavement or combinations thereof. When used, the aggregates are generally in an amount of from 70 to 99 wt %, from 80 to 95 wt %, or from 85 to 90 wt %, based on the total weight of the curable asphalt composition.

In addition to the foregoing components, the curable asphalt composition of the present invention can further comprise, or be free of, any one or combination of the following additives: styrene copolymers such as SBR and SBS, dispersants, stabilizers, curing promoters, adhesion promoters, pigments, other curing agents, anti-rutting agents, anti-stripping agents, flow modifiers and fillers such as cement. These additives are generally in an amount of 0 to 10 wt %, from 0.1 to 5 wt %, or from 0.2 to 1 wt %, based on the total weight of the curable asphalt composition.

The phenalkamine compound useful in the present invention can be prepared by essentially employing distillated cashew nutshell liquid (commercially available from Huada Saigao (Yantai) Science & Technology Company Limited), formalin or paraformaldehyde, and the polyamine. Optionally, solvents such as benzene, toluene or xylene can be used for removal of water produced during this reaction at an azeotropic distillation point. Nitrogen is also recommended for easing the water removal. The reaction may be conducted at a temperature from 60 to 130° C., or from 80 to 110° C. Diethylenediamine, triethylenetetramine (TETA), tetraethylenepentamine (TEPA) or polyoxypropylene amine is particularly suitable for preparing the phenalkamine compound.

The curable asphalt composition of the present invention can be supplied in two parts: a “Part A” (the asphalt emulsion) and a “Part B” (the waterborne epoxy resin). The process for preparing the curable asphalt composition of the present invention includes admixing Part A and Part B upon application. Other optional ingredients described above may be added to the asphalt composition as needed. For example, the preparation of the curable asphalt composition of the present invention is achieved by blending, in known mixing equipment, the asphalt emulsion and the waterborne epoxy resin. Any of the above-mentioned optional additives may be added to the composition during or prior to the mixing to form the curable asphalt composition.

Preferably, the curable asphalt composition of the present invention may be prepared by (I) mixing, at least one phenalkamine compound, at least one acid, water and, if present, at least one emulsifier to form an emulsion; (II) separately heating an asphalt; (III) mixing the separately heated asphalt and the emulsion obtained from step (I) to form an asphalt emulsion; (IV) mixing the asphalt emulsion and a waterborne epoxy resin to obtain the curable asphalt composition. In a preferred embodiment, at least one cationic emulsifier is used in step (I).

In step (I) of preparing the curable asphalt composition of the present invention, the phenalkamine compound, the acid, water and if present, the emulsifier can be mixed in any order. In some embodiments, the emulsifier is firstly mixed with the phenalkamine compound, followed by mixing with water. The acid is then added to form the emulsion. The emulsion obtained from the step (I) may have a pH value of from 1.5 to 3, from 1.7 to 2.5, or from 1.8 to 2.2.

In preparing the curable asphalt composition of the present invention, all components of the asphalt emulsion are typically mixed and dispersed at a temperature enabling the preparation of a well-dispersed emulsion. The emulsion in the step (I) may be heated to a temperature of 40° C. or higher, 50° C. or higher, or even 60° C. or higher, and at the same time, 90° C. or lower, 85° C. or lower, or even 80° C. or lower. The asphalt in step (II) can be heated to 120° C. or higher, or even 140° C. or higher.

The process of preparing the curable asphalt composition of the present invention optionally comprises another step (V): adding aggregates to the curable asphalt composition obtained from step (IV).

The process of preparing the curable asphalt composition of the present invention may be a batch or a continuous process. The mixing equipment used in the process may be any vessel and ancillary equipment well known to those skilled in the art, for example, a colloid mill.

Preferably, the curable asphalt composition of the present invention is prepared by firstly preparing the emulsion that comprises the phenalkamine compound, the acid, water and, if present, the emulsifier as described above. The emulsion obtained from the step (I) and the heated asphalt are then pumped into a colloid mill with high-shear mixing, so as to form an asphalt emulsion having asphalt droplets dispersed therein. The obtained asphalt emulsion is then mixed with the waterborne epoxy resin described above to form the curable asphalt composition of the present invention.

Curing the curable asphalt composition of the present invention may be carried out at a predetermined temperature and for a predetermined period of time sufficient to cure the curable asphalt composition. For example, the temperature of curing the curable asphalt composition is generally from −10 to 300° C., from −5 to 190° C., from 20 to 175° C., or from 21 to 50° C. The time of curing the curable asphalt composition may be chosen between 1 minute to 24 hours, between 5 minutes to 12 hours, or between 30 minutes to 2 hours. It is also operable to partially cure the curable asphalt composition and then complete the curing process at a later time.

Upon curing, the curable asphalt composition of the present invention provides one or more of the following properties: higher pull-off adhesion strength at room temperature or at 60° C. than that of a conventional rubber-modified asphalt emulsion such as a SBR-modified asphalt emulsion.

The curable asphalt composition of the present invention may be used in various applications, for example, as water-proofing material for architecture, as coatings such as anti-corrosion coating, and in road paving and maintenance applications. In particular, the curable asphalt composition is suitable for use in road paving and maintenance applications such as tack coats, fog seals, slurry seals and micro-surfacing. The curable asphalt composition can be supplied with conventional equipment commonly used for a two-component system. During application, Part A and Part B are stored in two different tanks, mixed on-site, and optionally mixed with other optional components in the curable asphalt composition such as aggregates, then applied to a substrate such as road surface.

### Examples

The following examples illustrate embodiments of the present invention. All parts and percentages in the examples are by weight unless otherwise indicated. The following materials are used in the examples:

A waterborne epoxy resin XZ92598, available from The Dow Chemical Company, has a solids content of from 63 to 65 wt % and is a nonionic emulsified bisphenol A diglycidyl ether (BADGE), wherein BADGE has an EEW of 193-204.

A waterborne epoxy resin XZ92533, available from The Dow Chemical Company, has a solids content of from 46 to 48 wt % and is a nonionic emulsified BADGE, wherein BADGE has an EEW of 475-550.

D.E.H. 641 hardener, available from The Dow Chemical Company, is a phenalkamine compound, which is a reaction product of cashew nut shell liquid with formaldehyde and ethylenediamine, and has an amine hydrogen equivalent weight (AHEW) of about 125.

Donghai 70^{#} asphalt is commercially available from Sinopec.

An asphalt emulsion based on 70^{#} asphalt is available from Sinopec.

INDULIN MQK-1M emulsifier is a cationic polyamidoamine emulsifier and is available from MeadWestvaco Corporation.

JEFFAMINE D230 is polyoxypropylenediamine available from Huntsman D.E.H. 20 hardener is diethylenetriamine available from The Dow Chemical Company.

Cashew nut shell liquid (“CNSL”) is available from Huada Saigao (Yantai) Science & Technology Company Limited.

Paraformaldehyde is available from Sinopharm Chemical.

D.E.H. 140 hardener is a polyamide hardener available from The Dow Chemical Company.

Isophorone diamine (IPDA), available from BASF, is a cylcoaliphatic amine and is used as a hardener.

m-xylylenediamine (MXDA), available from Mitsubishi Gas Chemical Company, is an aromatic amine and is used as a hardener.

D.E.H. 26 hardener is an aliphatic amine available from The Dow Chemical Company.

SBR latex 1502 has a solids content of 60 wt % and is available from Shandong Gaoshike Company.

Hydrochloric acid is available from Zhende Chemical.

The following standard analytical equipment and methods are used in the Examples.

### Tyndall Effect Test

A red laser pointer is held up to one side of a glass cup containing an asphalt emulsion, then the laser is turned on to go through the emulsion to observe light scatting effect. The light scattering effect can be used to decide whether the size of emulsion particles in an emulsion is comparable with or larger than light length. If a beam of light is visible to the naked eye when the laser goes through the emulsion, it indicates that the emulsion shows the Tyndall effect.

### Stability of an Asphalt Emulsion

The stability of an asphalt emulsion is determined using a SYD-0655 type stability test equipment according to the T0655-1993 method described in the JTG E20-2011 standard. Two hundred fifty (250) milliliter (ml) of an asphalt emulsion is stored in a tube having two outlets for 1 day and 5 days at room temperature, respectively. Emulsion samples are collected from each outlet after 1-day and 5-day storage, respectively, for measuring solids content. For the same time period of storage, solids content difference between the emulsion samples from the above two outlets is used to evaluate the stability of the asphalt emulsion. If the difference of solids content of the asphalt mulsion between the above two outlets is less than 1% after one-day storage, and less than 5% after 5-day storage, the asphalt emulsion has satisfactory stability.

### Pull-off Adhesion Strength

A curable asphalt composition or a SBR-modified asphalt emulsion is paved on a concrete board to form a layer. After emulsions break, six dollies are placed onto the surface of the layer. The resulting sample is placed at room temperature for 4-5 days for complete curing to form a tack coat with a thickness of around 1 millimeter (mm) Then, a pull-off tester is employed to measure the pull-off adhesion strength of the tack coat from the concrete substrate at a pulling rate of 300 newtons per second (N/s), at room temperature and 60° C., respectively. Three samples are employed for measuring the pull-off adhesion strength.

### Synthesis of Phenalkamine Compound I

The phenalkamine compound I was prepared by reacting CNSL, paraformaldehyde, and polyoxypropylenediamine, according to the following procedure:

A 1-litre round flask was equipped with a Dean-Stark water trap connected to a refluxing condenser, a mechanical stirrer and a nitrogen adapter. 297 grams (1.0 mole) of CNSL were mixed with 460 grams (2.0 moles) of polyoxypropylenediamine; then the mixture was stirred to be homogeneous and heated up to 80° C. With continuous mechanical stirring, mild nitrogen flow and cooling water circulation, 66 grams (2.2 moles) of paraformaldehyde were charged into the flask over a time period of 45 to 60 minutes. Then, 31.9 grams (0.3 mole) of xylene were added to the flask and the flask temperature was raised to 110° C. Water generated during reaction was removed by xylene under azeotropic distillation. When CNSL was consumed up by observing thin layer chromatography (TLC) under 254 nanometer (nm) ultraviolet, the reaction was stopped. The resultant product appears wine red and viscous, having a viscosity of around 720 centipoises (cps) (25° C., ASTM D2196) and an amine value of about 270 milligram potassium hydroxide per gram sample (mg KOH/g) (ISO 9702). The phenalkamine compound I obtained from the above procedure had a polystyrene equivalent weight average molecular weight (M_{W}) of 646 and a polydispersity index (PDI) of 1.23 according to gel permeation chromatography (GPC) analysis.

### Synthesis of Phenalkamine Compound II

The phenalkamine compound II was prepared by reacting CNSL, diethylenetriamine, and paraformaldehyde, according to the following procedure:

A 1-litre round flask was equipped with a Dean-Stark water trap connected to a refluxing condenser, a mechanical stirrer and a nitrogen adapter. 297 grams (1.0 mole) of CNSL were mixed with 222 grams (2.0 moles) of diethylenetriamine; then the mixture was stirred to be homogeneous and heated up to 80° C. With continuous mechanical stirring, mild nitrogen flow and cooling water circulation, 66 grams (2.2 moles) of paraformaldehyde were charged into the flask over a time period of 45 to 60 minutes. Then, 31.9 grams (0.3 mole) of xylene were added to the flask and the flask temperature was raised to 110° C. Water generated during reaction was removed by xylene under azeotropic distillation. When CNSL was all consumed by observing TLC under 254 nm ultraviolet, the reaction was stopped. The resultant product appears wine red and viscous, having a viscosity of around 2,800 cps (25° C., ASTM D2196) and an amine value of about 510 mg KOH/g (ISO 9702). The phenalkamine compound II obtained from the above procedure had a polystyrene equivalent M_{w} of 1203 and a PDI of 1.61 according to the GPC analysis.

### Comparative Examples (Comp Exs) A-B

An asphalt emulsion based on 70^{#} asphalt was mixed with SBR latex at a SBR concentration of 4 wt % or 10 wt % to form a SBR-modified asphalt emulsion of Comp Exs A and B, respectively. Weight percentage of SBR is based on the total weight of the asphalt and solids weight of the SBR latex.

### Examples (Exs) 1-6 and Comp Exs C-F

Curable asphalt compositions were prepared based on formulations described in Table 1. 24 grams of INDULIN MQK-1M emulsifier were mixed with a hardener; then 480 grams of water were added to the resultant mixture. Hydrochloric acid (HCl) was added to the resultant mixture to adjust pH value to 1.5˜2.5 to form an emulsion. The obtained emulsion was then heated to 60-90° C. and poured into a colloid mill. Meanwhile, solid Donghai 70^{#} asphalt was heated to about 140° C. and added into the colloid mill under agitation for 2 minutes to obtain an asphalt emulsion (“Part A”). Part A was further blended with a waterborne epoxy (“Part B”) to form an epoxy-modified curable asphalt composition.

### Exs 7-8

Curable asphalt compositions of Exs 7-8 were prepared without the use of INDULIN MQK-1M emulsifier based on formulations described in Table 1. Twenty four (24) grams of Phenalkamine Compound I (for Ex 7) or Phenalkamine Compound II (for Ex 8) were mixed with 480 grams of water. Hydrochloric acid (HCl) was added to the resultant mixture to adjust pH value to 1.5˜2.5 to form an emulsion. The obtained emulsion was then heated to 60-90° C. and poured into a colloid mill. Meanwhile, 550 grams of solid Donghai 70^{#} asphalt was heated to about 140° C. and added into the colloid mill under agitation for 2 minutes to obtain an asphalt emulsion (“Part A”). Part A was further blended with a waterborne epoxy (“Part B”) to form an epoxy-modified curable asphalt composition.

TABLE 1

| | Waterborne Epoxy Resin | | | | |
|---|---|---|---|---|---|
| | | solids | | | |
| | | weight | Hardener | | Asphalt |
| | Type | (gram) | Type | gram | (gram) |
| Ex 1 | XZ92598 | 15 | D.E.H. 641 | 9.15 | 85 |
| | | | hardener | | |
| Ex 2 | XZ92598 | 30 | D.E.H. 641 | 18.3 | 70 |
| | | | hardener | | |
| Ex 3 | XZ92533 | 15 | Phenalkamine | 7.7 | 85 |
| | | | Compound I | | |
| Ex 4 | XZ92533 | 5 | Phenalkamine | 0.29 | 95 |
| | | | Compound II | | |
| Ex 5 | XZ92533 | 10 | Phenalkamine | 0.57 | 90 |
| | | | Compound II | | |
| Ex 6 | XZ92533 | 15 | Phenalkamine | 0.86 | 85 |
| | | | Compound II | | |
| Ex 7 | XZ92598 | 6.7 | Phenalkamine | 3.71 | 85 |
| | | | Compound I | | |
| Ex 8 | XZ92598 | 13.4 | Phenalkamine | 3.71 | 85 |
| | | | Compound II | | |
| Comp | XZ92598 | 15 | D.E.H. 140 | 7 | 85 |
| Ex C | | | hardener | | |
| Comp | XZ92598 | 15 | IPDA | 3.12 | 85 |
| Ex D | | | | | |
| Comp | XZ92598 | 15 | MXDA | 2.44 | 85 |
| Ex E | | | | | |
| Comp | XZ92598 | 15 | D.E.H. 26 | 2 | 85 |
| Ex F | | | hardener | | |

The asphalt emulsions (Part A) of the curable asphalt compositions of Exs 2, 7 and 8 were used for stability test. These asphalt emulsions did not show sedimentation or phase separation after 1-day storage at room temperature. In addition, solids content difference of the emulsions was less than 1% even after 5-day storage at room temperature. It indicates that these phenalkamine containing asphalt emulsions have sufficient stability for storage and transportation, therefore, to meet the industrial requirements such as the JTG E20-2011 standard. The asphalt emulsions (Part A) of Exs 7-8 surprisingly exhibited the Tyndall effect and showed satisfactory stability without the use of any conventional emulsifiers. In contrast, the asphalt emulsions of the curable asphalt compositions of Comp Exs C-F showed significant sedimentation and phase separation after only 1-day storage at room temperature. It indicates that the asphalt emulsions of the curable asphalt compositions of Comp Exs C-F do not have satisfactory stability.

Table 2 shows properties of tack coats made from curable asphalt compositions of the present invention and SBR-modified asphalt emulsions. The amount of SBR solids for Comp Ex A is similar as the amount of solids of the waterborne epoxy resin in the curable asphalt composition of Ex 4. The tack coat made from Ex 4 showed higher pull-off adhesion strength both at room temperature (RT) and at 60° C. than that of Comp Ex A. The amount of SBR solids for Comp Ex B is the same as the amount of solids of the waterborne epoxy resin in the curable asphalt composition of Ex 5. The tack coat made from Ex 5 also showed higher pull-off adhesion strength both at RT and at 60° C. than that of Comp Ex B. Tack coats made from the curable asphalt compositions of Exs 1-3 and 6-8 all showed higher pull-off adhesion strength both at room temperature and at 60° C. relative to that of the SBR-modified asphalt emulsions of Comp Exs A-B. For Exs 1-8, the pull-off adhesion strength at 60° C. increased by at least 50%, and the pull-off adhesion strength at room temperature increased by at least 40%, compared to those of Comp Exs A-B.

TABLE 2

| | Pull-off adhesion strength | Pull-off adhesion strength |
|---|---|---|
| | @ RT, megapascals (MPa) | @ 60° C., MPa |
| Comp | 0.76 | 0.2 |
| Ex A | | |
| Comp | 0.71 | 0.2 |
| Ex B | | |
| Ex 1 | 1.57 | 0.38 |
| Ex 2 | 1.88 | 0.6 |
| Ex 3 | 1.83 | 0.36 |
| Ex 4 | 1.09 | 0.33 |
| Ex 5 | 1.33 | 0.4 |
| Ex 6 | 1.49 | 0.4 |
| Ex 7 | 1.83 | 0.36 |
| Ex 8 | 1.43 | 0.38 |

Table 3 shows the pull-off adhesion strength properties of tack coats made from asphalt compositions of Comp Exs C-F. The asphalt compositions of Comp Exs C-F had the same dosage of the waterborne epoxy resin (solids weight) as Exs 1, 3 and 6. Polyamide hardeners are known to cure epoxy resins much slower at room temperature than phenalkamine hardeners. The asphalt composition containing polyamide (Comp Ex C) was not suitable for road paving applications, which usually requires the paved road open to traffic within 3 hours. In addition, tack coats made from the asphalt compositions of Comp Exs C-F showed much lower pull-off adhesion strength at room temperature as compared to that of tack coats made from the curable asphalt compositions of Exs 1, 3 and 6. It indicates that the inventive asphalt compositions comprising the phenalkamine hardener provide tack coats with surprisingly higher pull-off adhesion strength at room temperature, compared to the asphalt compositions comprising different hardeners.

TABLE 3

| | Comp | Comp | Comp | Comp |
|---|---|---|---|---|
| | Ex C | Ex D | Ex E | Ex F |
| Pull-off adhesion | 1.2 | 0.85 | 0.81 | 0.74 |
| strength @ RT, MPa | | | | |

1. A curable asphalt composition, comprising:
(i) an asphalt emulsion comprising: (a) asphalt; (b) a phenalkamine compound; (c) 0-5 wt % of an emulsifier, based on the total weight of the asphalt emulsion; (d) an acid; and (e) water; and
(ii) a waterborne epoxy resin having a solids content.

2. The curable asphalt composition of claim 1, wherein the phenalkamine compound comprises a compound having Formula (I): 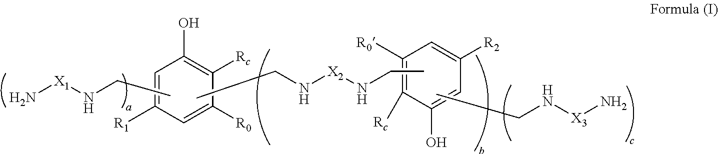
wherein R₀ or R₀′ is independently a straight-chain alkyl with 15 carbons containing 0 to 3 C═C bond(s), or a straight-chain alkyl with 17 carbons containing 1 to 3 C═C bond(s); R₁ or R₂ is independently hydrogen or hydroxyl; R_{c} is hydrogen or carboxyl; a is an integer from 0 to 2; b is an integer from 0 to 20; c is 0 or 1; wherein a+b+c≠0; X₁, X₂ or X₃ is independently a bivalent or multivalent group selected from the group consisting of an aliphatic ethylene, an amino ethylene, an aliphatic carbonyl, a polyoxyalkylene, a cycloaliphatic, an aromatic, and a polycyclic structure.

3. The curable asphalt composition of claim 2, wherein X₁, X₂ or X₃ is independently an aliphatic ethylene.

4. The curable asphalt composition of claim 1, wherein the asphalt emulsion comprises, based on the total weight of the asphalt emulsion, from 0.01 to 3 wt % of the emulsifier.

5. The curable asphalt composition of claim 1, wherein the emulsifier comprises a cationic emulsifier.

6. The curable asphalt composition of claim 2, wherein X₁, X₂ or X₃ is independently a group having a HLB value of 4 or higher.

7. The curable asphalt composition of claim 6, wherein X₁, X₂ or X₃ is independently a group selected from an amino ethylene, a polyoxyalkylene, or mixtures thereof.

8. The curable asphalt composition of claim 6, wherein the curable asphalt composition is free of emulsifier.

9. The curable asphalt composition of claim 1, wherein the equivalent ratio of epoxy group in the waterborne epoxy resin to active hydrogen in the phenalkamine compound is from 1:0.5 to 1:2.

10. The curable asphalt composition of claim 1, wherein the weight ratio of solids of the waterborne epoxy resin to the asphalt is from 0.01:1 to 10:1.

11. The curable asphalt composition of claim 1, wherein the weight ratio of solids of the waterborne epoxy resin to the asphalt is from 0.04:1 to 1:1.

12. The curable asphalt composition of claim 1, wherein the waterborne epoxy resin is a dispersion of a solid epoxy resin.

13. The curable asphalt composition of claim 1, wherein the asphalt emulsion comprises, based on the total weight of the asphalt emulsion, from 45 to 65 wt % of the asphalt.

14. The curable asphalt composition of claim 1, wherein the curable asphalt composition further comprises aggregates, fillers, stabilizers, curing promoters, or mixtures thereof.

15. A process of preparing the curable asphalt composition of claim 1, comprising:
(I) mixing an emulsifier, a phenalkamine compound, an acid, and water to form an emulsion;
(II) separately heating asphalt;
(III) mixing the separately heated asphalt and the emulsion obtained from step (I) to form an asphalt emulsion, wherein the asphalt emulsion contains 0-5 wt % of the emulsifier, based on the total weight of the asphalt emulsion;
(IV) mixing the asphalt emulsion and a waterborne epoxy resin to obtain the curable asphalt composition.

16. The curable asphalt composition of claim 7, wherein the curable asphalt composition is free of emulsifier.

17. The curable asphalt composition of claim 1, wherein the weight ratio of solids of the waterborne epoxy resin to the asphalt is from 0.01:1 to 10:1; the waterborne epoxy resin is a dispersion of a solid epoxy resin; the asphalt emulsion comprises, based on the total weight of the asphalt emulsion, from 45 to 65 wt % of the asphalt, and the curable asphalt composition further comprises aggregates, fillers, stabilizers, curing promoters, or mixtures thereof.

18. The curable asphalt composition of claim 2, wherein the weight ratio of solids of the waterborne epoxy resin to the asphalt is from 0.01:1 to 10:1; the waterborne epoxy resin is a dispersion of a solid epoxy resin; the asphalt emulsion comprises, based on the total weight of the asphalt emulsion, from 45 to 65 wt % of the asphalt, and the curable asphalt composition further comprises aggregates, fillers, stabilizers, curing promoters, or mixtures thereof.

19. The curable asphalt composition of claim 1, wherein the asphalt emulsion comprises, based on the total weight of the asphalt emulsion, from 0.01 to 3 wt % of the emulsifier, the equivalent ratio of epoxy group in the waterborne epoxy resin to active hydrogen in the phenalkamine compound is from 1:0.5 to 1:2, and the weight ratio of solids of the waterborne epoxy resin to the asphalt is from 0.01:1 to 10:1.

20. The curable asphalt composition of claim 1, wherein the asphalt emulsion comprises, based on the total weight of the asphalt emulsion, from 0.01 to 3 wt % of the emulsifier, and the emulsifier comprises a cationic emulsifier.
